(19) United States
(12) Patent Application Publication
(10) Pub. No.: US 2007/0072736 A1
(43) Pub. Date: Mar. 29, 2007

(54) Continuously variable ratio transmission unit

(76) Inventors: Andrew Damian Defreitas, Standish (GB); Adrian Woods, Chodley (GB)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/564,685

(22) PCT Filed: May 18, 2004
(86) PCT No.: PCT/GB04/02139

§ 371 Date: Jul. 6, 2006

(30) Foreign Application Priority Data
Jul. 12, 2003 (GB) 0316379.7

(51) Int. Cl. F16H 15/38

(52) U.S. Cl. 476/40

(57) ABSTRACT

There is disclosed a continuously variable ratio transmission unit of rolling traction type, comprising a pair of races (10,12) between which torque is transmitted by at least one roller (26), the roller being movable to provide variation in the transmission ratio and being subject to an adjustable roller reaction force by a roller actuator (28), a traction loading actuator (35) arranged to urge the rollers and discs into engagement with each other with a force which is varied in sympathy with the roller reaction force during normal variator operation, and a pre-loading arrangement (80) which is arranged to urge the rollers and discs into engagement with each other at least during a cold start wherein the pre-loading arrangement is adapted to apply a pre-loading force is reduced with increasing operating temperature.

The present invention is concerned with a continuously variable ratio transmission unit (“variator”) of rolling traction type, and particularly with a pre-loading arrangement of such a unit.

In a rolling traction type variator drive is transmitted between a pair of races by means of at least one roller (and more typically a set of rollers) which is movable in accordance with changes in variator ratio. A roller control actuator, which is typically hydraulic, applies an adjustable roller reaction force to the roller's mountings to influence the variator's behaviour.

To enable transfer of drive between the races by the roller, the races and the roller must be urged into engagement with each other. It has long been recognised that for the sake of variator efficiency and longevity the necessary traction loading force should be varied in sympathy with the roller reaction force. Sustained, excessive traction loading force produces high energy dissipation at the roller/race interface and increases wear to the components. On the other hand when the roller reaction force is large, a correspondingly large traction loading force is required in order to avoid excessive slip at the roller/race interface. It is conventional to provide within the variator a traction loading actuator which applies the traction loading force either to a race of the variator or to the rollers, the actuator being arranged to vary the traction loading force as necessary. By way of example reference is directed to Torotrak (Development) Limited's European patent EP 894210 and its US counterpart U.S. Pat. No. 6,030,310, which disclose a hydraulic arrangement for controlling both the roller reaction force and the traction loading force. These documents are incorporated herein by reference. A hydraulic actuator acting on a race in the form of a variator disc applies the traction loading force which is varied in proportion to the roller reaction force.

Known arrangements for applying the traction loading force are typically not fully effective during a cold start of the power train nor in the subsequent period of cold running during which the power train, and specifically the variator, warms up toward its operating temperature. Upon start up a finite time is required, in the known hydraulic systems, to generate the necessary pressure. Furthermore high fluid viscosity at low running temperatures can impair or even prevent functioning of the traction loading actuator.

This is particularly problematic because at low temperature the film of “traction fluid” maintained between roller and races is itself of increased viscosity, creating a need for increased end load at low temperature.

To provide the necessary traction loading force at these times a pre-stressed spring is conventionally incorporated in the variator. This has in known variators taken the form of a Belleville washer acting upon one of the variator races and provides a pre-loading force, even while the traction loading actuator is ineffective, to provide roller/race traction in the initial cold phase of operation.

The present inventors have recognised and addressed problems arising in connection with the known pre-loading arrangements. A particular problem in this regard is that since the desired roller/race force varies, a pre-load which is sufficient for all operating conditions in the start up phase may be excessive at some times during normal running.

In accordance with the present invention there is provided a continuously variable ratio transmission unit of rolling traction type, comprising a pair of races between which torque is transmitted by at least one roller, the roller being movable to provide for variation in the transmission ratio and being subject to an adjustable roller reaction force by a roller actuator, a traction loading actuator arranged to urge the rollers and discs into engagement with each other with a force which is varied in sympathy with the roller reaction force during normal variator operation, and a pre-loading arrangement which is arranged to urge the rollers and discs into engagement with each other at least during a cold start, wherein the pre-loading arrangement is adapted to apply a pre-loading force is reduced with increasing operating temperature.

In a particularly preferred embodiment of the present invention the pre-loading arrangement comprises a pre-load adjustment actuator having a working chamber in which a body of thermally expansive material is confined, such that force exerted by the pre-load adjustment actuator corresponds to pressure within the working chamber and varies with operating temperature.

Still more preferably the pre-load adjustment actuator comprises a piston and cylinder arrangement defining the working chamber.

Preferably the pre-loading arrangement further comprises a pre-stressed spring arranged to provide the pre-loading force, the pre-load adjustment actuator being arranged to act in opposition to the spring and so to relieve the pre-loading force as operating temperature increases.

In a further preferred embodiment the end load adjustment actuator and the race upon which it acts are mounted upon a common shaft, the race being capable of movement along the shaft and the actuator comprising a disc which is fixed relative to the shaft and a piston movable along the shaft, the working chamber being defined therebetween.

In a constructionally convenient embodiment a sleeve disposed around the disc and piston serves as a cylinder within which the piston forms a sealed, sliding fit and also serves to couple the movable race to the piston.

A specific embodiment of the present invention will now be described by way of example only, with reference to the accompanying drawings in which:

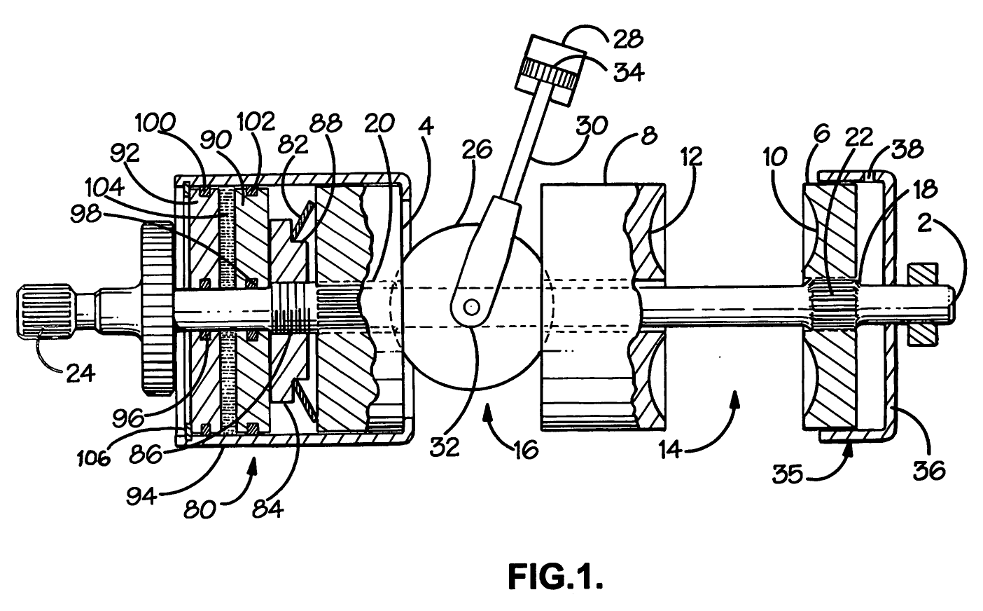

FIG. 1 is a schematic representation of a variator embodying the present invention;

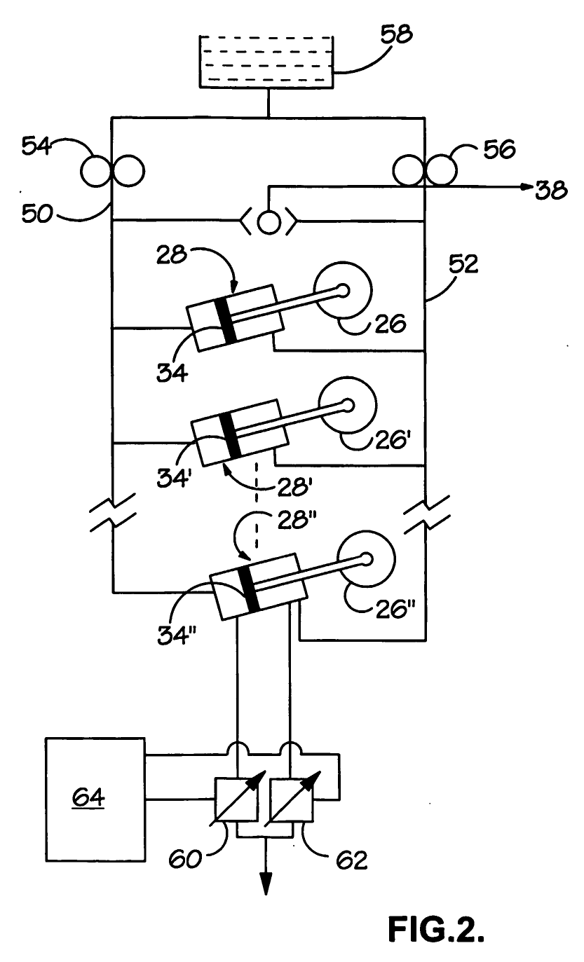

FIG. 2 is a diagram of a hydraulic circuit used to control the variator illustrated in FIG. 1, this circuit being known in itself; and

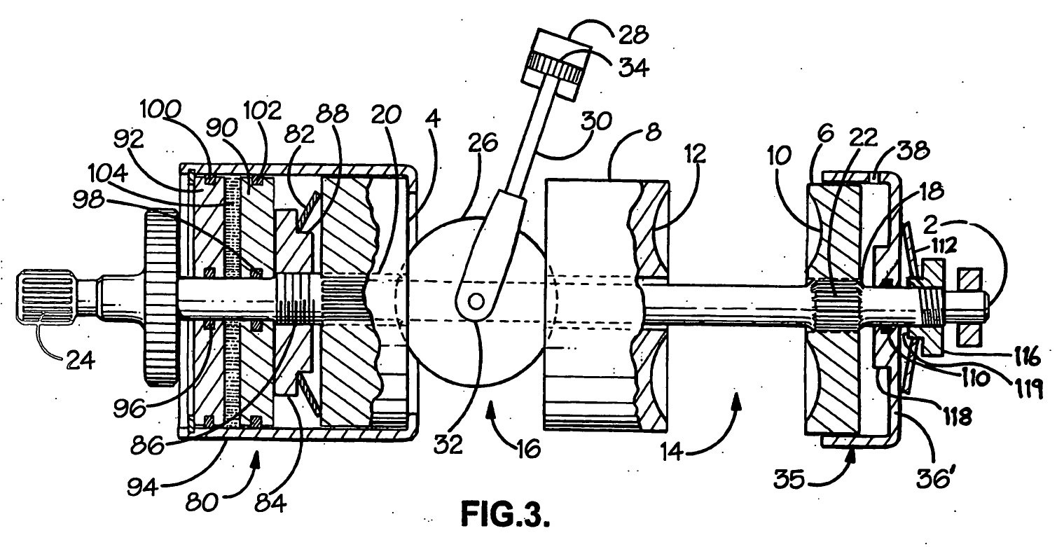

FIG. 3 is a schematic representation of a further variator embodying the present invention.

The variator illustrated in FIG. 1 is of the toroidal-race, rolling traction type. Mounted around a main shaft 2 are first and second outer discs 4, 6 and a single inner disc 8. The second outer disc 6, and part of the inner disc 8, are illustrated in section so that it can be seen how their opposed faces 10, 12 are shaped to form respective races defining between themselves a toroidal cavity 14. Opposed faces of the first outer disc 4 and of the inner disc 8 are similarly shaped to form a toroidal cavity 16, although the shape of these faces is not seen in the drawing. The first outer disc 4 is coupled to the main shaft 2 through splines 20 which permit some movement of the disc along the shaft while ensuring that the disc and shaft cannot rotate relative to each other. Likewise the second outer disc 6 is splined to the shaft at 22 to permit disc movement along the shaft while preventing rotation relative to it. The inner disc 8 is journalled to be rotatable about and relative to the main shaft 2.

Drive from an engine or other rotary power source is applied to the main shaft 2 through a gear 24, the outer discs 4, 6 being caused to rotate along with the shaft. Drive is transmitted from the outer discs 4, 6 to the inner disc 8 through a set of rollers disposed within the toroidal cavities 14, 16. In FIG. 1 only a single representative roller 26 is shown, other rollers being omitted for the sake of representational simplicity. However in practice two, or more typically three, rollers are normally provided in each of the cavities 14, 16, each being generally similarly formed and mounted. Each roller is acted on by a respective roller control actuator, an example of which is seen at 28, serving to apply a variable force (referred to herein as the roller reaction force) to the roller 26. Rotation of the outer discs 4,6 causes the rollers such as 26 to rotate and so to drive the inner disc 8 (and it should be understood that drive can equally well pass from the inner disc 8 to the outer discs 4, 6, since in a motor vehicle transmission the direction of energy transfer through the variator may be reversed from time to time).

The rollers are able to “precess”—that is, to change the angle of inclination of their own axes to the axis of the main shaft 2. This precession is accompanied by a change in the relative diameters of the circular paths traced out upon the races such as 10, 12 by the roller, and a corresponding change in the variator ratio. Various means for controlling the roller inclination are known in the art. The illustrated exemplary variator is of “torque-controlled” type in which the roller reaction force, applied by the roller control actuator 28 along a generally circumferential direction, is balanced by a net force applied to the roller, along the opposite direction, by the action thereupon of the discs 4, 8. The net force applied to the roller by the discs is proportional to the variator “reaction torque”, defined as the sum of the variator input and output torques. The roller is free to rotate about a stem 30 coupling the roller's mountings 32 to a piston 23 of the roller control actuator 28, and adopts a position which corresponds to the prevailing ratio between the input and output speeds of the variator. By controlling the roller reaction forces applied by the roller control actuators, the variator reaction torque is controlled. Consequent changes in speed at the variator input and output are accompanied by changes in variator ratio and consequent precessional movement of the rollers 26. The principles involved, and the construction of a torque controlled variator, are known and are explained in various patents held by Torotrak (Development) Limited including in particular European patent EP444086 and its US counterpart U.S. Ser No. 07/689,774, which are incorporated herein by reference.

Traction between the rollers such as 26 and the races such as 10, 12 is necessary and to provide this the rollers and races must be urged into engagement with each other. The exemplary embodiment illustrated in FIG. 1 uses, in a manner known in itself, a hydraulic actuator 35 to apply the required traction loading force to the second variator disc 6. In FIG. 1 a simple arrangement is shown in which the disc 6 acts as a piston within a cylinder 36. Pressurised hydraulic fluid is introduced through a port 38 and applies a force to the second outer disc 6, urging it toward the inner disc 8. Rollers in the second cavity 14 are thus subject to an engagement pressure from the discs 6, 8. Also since the inner disc 8 has some “float” along the direction of the main shaft 2, the loading force is transmitted to rollers such as 26 in the first cavity 16, these rollers being thus subject to an engagement pressure from the discs 4, 6.

The rollers and discs are not in fact brought into contact with each other despite large pressures between them, a thin film of “traction fluid” being maintained between these components in operation of the variator.

A more sophisticated form of hydraulic actuator for applying the traction loading force can be found in Torotrak (Development) Limited's European patent 894210 and its US counterpart U.S. Pat. No. 6,030,310. These documents are incorporated herein by reference.

The traction loading force is varied in sympathy with the traction force applied to the roller by its actuator 28. In the present embodiment this is achieved by means of hydraulic circuitry. Suitable hydraulics are known from earlier publications by Torotrak (Development) Limited and will be only briefly described herein. For further details on this aspect reference is directed to Torotrak's European patent EP 894210, to its US counterpart U.S. Pat. No. 6,030,310, and also to Torotrak's International patent application PCT/GB02/01551, published under number WO 02/079675. These documents are incorporated herein by reference.

FIG. 2 is a simplified representation of the hydraulic circuit disclosed in EP894210 and comprises a pair of flow lines 50, 52 each of which is supplied with a continual flow of fluid by a respective pump 54, 56 (a single pump with a flow splitting arrangement may alternatively be used) drawing fluid from sump 58. Pressures in the flow lines 50, 52 are adjustable by means of valves 60, 62 under the control of electronics 64 which manage the transmission. Fluid flows continually out of the valves 60, 62 (and back to sump 58) and the valves each create an adjustable back pressure in their respective line 50, 52. The pressures in the two lines 50, 52 are applied to opposite sides of the pistons 34, 34′ . . . 34″ controlling the rollers 26, 26′ . . . 26″ of the roller control actuators 28, 28′ . . . 28″. In this way the reaction forces exerted by the rollers are adjusted by the electronics 64.

Actuator 28″ serves as a so-called “master” providing an end stop function, flow through the two lines 50, 52 having to pass through respective exit ports 66, 68. Excessive roller/piston movement causes the piston 34″ to close one or other of the exit ports, creating a hydraulic lock which prevents further piston movement in the relevant direction.

In order to vary the traction loading force in sympathy with the roller reaction force a “higher pressure wins” valve arrangement 70 connected between the two flow lines 50, 52 serves to select whichever of the flow lines is, at any given time, at higher pressure and connects it to the port 38 of the traction loading actuator 35. The result in this particular circuit is that the traction loading force is proportional to the higher of the two flow line pressures and hence is varied in sympathy with the reaction force applied by the actuators 28 to the rollers.

As explained above, the traction loading actuator 35 can be ineffective at low operating temperatures such as are found before the driveline has had time to warm up. Inadequate traction loading produces the risk of excessive slip between rollers and discs, which can be highly deleterious. A pre-load arrangement 80 (FIG. 1) serves both to exert the force necessary to provide roller/disc traction during cold running, and to reduce this force in accordance with the present invention as operating temperature increases.

It is known to utilize a pre-loading spring to provide pre-loading. In the illustrated embodiment such a spring is provided in the form of a Belleville washer 82 of frusto-conical shape which is pre-stressed between a lock nut 84 and the rear face of the outer variator disc 4. The lock nut 84 engages with a thread 86 upon the main shaft 2 and is thereby fixed relative to the shaft. It has a shoulder 88 serving to locate the Belleville washer 82. The washer exerts a pre-loading force upon the outer disc 4 during cold running, urging the rollers and discs into engagement with each other.

A pre-loading adjustment actuator for relieving the loading applied to the outer disc 4 by the spring 82 is formed by a fixed actuator disc 90 and a movable actuator disc 92, serving as a piston within a cylinder formed by a sleeve 94. Disc 94 is fixed by virtue of its abutment against lock nut 84 and in fact the disc and nut could be formed as a single component. Both actuator discs 90, 92 are mounted around the main shaft 2 for rotation therewith and carry respective inner seals 96, 98 which seal against the shaft. Also both actuator discs 90, 92 carry respective outer seals 100, 102 which seal against the sleeve 94 while permitting relative sliding motion. Hence a sealed working chamber is formed between the two actuator discs 90, 92 and this is filled with a body of thermally expansive material 104. In the present embodiment this comprises paraffin wax, although other materials could be chosen to provide a volume/temperature characteristic suited to the specific application.

The sleeve 94 carries a circlip 106 which abuts the outer face of the movable actuator disc 92. The sleeve 94 also has a radially inwardly projecting rim which abuts the inner face of outer variator disc 4, so that pressure within the working chamber causes a force to be exerted, through the sleeve, upon the variator disc 4 in a direction away from the other discs. The effect of pressure within the working chamber is thus to relieve the pre-loading applied by the spring 82.

In operation, the volume of material 104 is at a minimum when the variator is cold, in particular upon a cold start. In fact the paraffin wax used in the illustrated embodiment is solid at this stage. Movable actuator disc 92 is at the right hand extreme of its travel. Consequently in this condition the pre-loading applied to the outer variator disc 4 is at a maximum.

Following start-up the variator operating temperature progressively increases and the material 104 within the working chamber tends to expand as it is warmed. Increased pressure within the working chamber causes the movable actuator disc 92 to move leftward, causing corresponding displacement of the sleeve 94 and so the variator disc 4 to the left against the force of the spring 82. In the present embodiment this results in the variator disc 4 being drawn into abutment with the lock nut 84, the pre-loading force being thereby removed altogether.

The paraffin wax used in the present embodiment undergoes a 15% volume increase upon change of state from solid to liquid and it is this expansion, which takes place as the variator warms up toward its normal operating temperature, which causes relief of the pre-loading. The process is consequently a rapid one once a selected operating temperature is reacted.

The arrangement illustrated in FIG. 1 serves to remove the pre-load on the variator discs once a sufficiently high operating temperature is reached. This is advantageous in that it allows use of a stiff spring 82, to provide the large pre-load required during a cold start, while also allowing the traction loading force to be controlled by the traction loading actuator 35 under normal warm operating conditions. Note however that during a warm start of the engine/transmission, the FIG. 1 arrangement does not provide a pre-loading force. Consequently it is necessary to arrange in some other way for application of the required traction loading during a warm start.

FIG. 3 illustrates a variator which is a development of that shown in FIG. 1. Like components are given the same reference numerals and it will be apparent that the pre-load arrangement 80, as well as the variator rollers and discs, are identical in the two drawings. The differences lie in the traction loading actuator 35, whose cylinder 36′ is in the FIG. 3 embodiment capable of sliding motion upon the shaft 2, its radially inner surface having an annular recess containing a seal 110 to maintain integrity of the actuator's working chamber. A second pre-loading spring 112, formed as a Belleville washer, bears upon the outermost face of the cylinder 36′. A ring nut 116 outboard of the second spring 112 is screwed to the shaft 2 and serves as a stop against which the second spring 112 acts. On the inner face of the cylinder 36′, within its working chamber, is formed an axially projecting spigot 118.

The second pre-loading spring 112 is such as to exert a smaller force than the first mentioned pre-loading spring 82. Typically the second spring is chosen to be less stiff than the first.

In operation, during a cold start the effect of the first spring 82 dominates, displacing the discs and rollers rightward (as seen in the drawing) so that the outer disc 10 abuts the spigot 118. Note that by virtue of the spigot 118, the disc cannot move so far to the right as to close the port 38. The second spring 112 is fully compressed, bringing the outer face of the cylinder 36′ up against a stop formed as a boss 119 formed on ring nut 116. The effect, as in the previously described embodiment, is that upon cold start a pre-load determined by the first pre-load spring 82 is provided. As the variator warms up, the first spring 82 is relieved by the adjustment actuator as before.

During warm operation, and particularly during warm start-up, the effect of the second pre-loading spring 112 is to ensure that the traction loading force does not fall below a predetermined value. While sufficient fluid pressure is provided in the cylinder 36′ to keep the outer disc 10 off the spigot 118, traction loading is determined solely by the fluid pressure. If this pressure falls sufficiently cylinder 36′ is advanced by the spring to bring its spigot 118 into abutment with the outer disc 10, applying the spring's force to the disc. Hence upon warm start up the necessary pre-loading is available.

It will be apparent that numerous variations and modifications could be made without departing from the scope of the invention. For example, while the above described variator is of “torque-controlled” type, the principles involved in the present invention are equally relevant to ratio-controlled variators, in which the hydraulics serve to maintain a roller portion determined by the associated control electronics. Furthermore the invention could potentially be applied to the type of “half toroidal” variator in which the roller/disc traction loading is exerted upon the rollers rather than upon the variator discs.

1. A continuously variable ratio transmission unit of rolling traction type, comprising
a pair of races between which torque is transmitted by at least one roller, the roller being movable to provide for variation in the transmission ratio and being subject to an adjustable roller reaction force by a roller actuator,
a traction loading actuator arranged to urge the rollers and discs into engagement with each other with a force which is varied in sympathy with the roller reaction force during normal variator operation, and
a pre-loading arrangement which is arranged to urge the rollers and discs into engagement with each other at least during a cold start,
wherein the pre-loading arrangement is adapted to apply a pre-loading force which is reduced with increasing operating temperature.

2. A continuously variable ratio transmission unit as claimed in claim 1 wherein the pre-loading arrangement comprises a pre-load adjustment actuator having a working chamber in which a body of thermally expansive material is confined, such that force exerted by the pre-load adjustment actuator corresponds to pressure within the working chamber and varies with operating temperature.

3. A continuously variable ratio transmission unit as claimed in claim 2 wherein the pre-load adjustment actuator comprises a piston and cylinder arrangement defining the working chamber.

4. A continuously variable ratio transmission unit as claimed in claim 2 wherein the pre-loading arrangement further comprises a pre-stressed spring arranged to provide the pre-loading force, the pre-load adjustment actuator being arranged to act in opposition to the spring and so to relieve the pre-loading force as operating temperature increases.

5. A continuously variable ratio transmission unit as claimed in claim 2 wherein the end load adjustment actuator is arranged to act upon one of the races and is mounted to rotate therewith.

6. A continuously variable ratio transmission unit as claimed in claim 2 wherein the end load adjustment actuator and the race upon which it acts are mounted upon a common shaft, the race being capable of movement along the shaft and the actuator comprising a disc which is fixed relative to the shaft and a piston movable along the shaft, the working chamber being defined therebetween.

7. A continuously variable ratio transmission unit as claimed in claim 6 wherein a sleeve disposed around the disc and piston serves as a cylinder within which the piston forms a sealed, sliding fit and also serves to couple the movable race to the piston.

8. A continuously variable ratio transmission unit as claimed in claim 1 wherein the pre-loading arrangement and the traction loading actuator act on different races.

9. A continuously variable ratio transmission unit as claimed in claim 4 wherein, in addition to the pre-loading spring, a second spring is provided whose force is not relieved by the pre-load adjustment actuator, the second spring ensuring a minimum traction loading force.

10. (canceled)
